(19) United States
(12) Patent Application Publication
(10) Pub. No.: US 2007/0185968 A1
(43) Pub. Date: Aug. 9, 2007

(54) Communicating with a remote control

(75) Inventors: Scott White, Austin, TX (US); James Cansler JR., Pflugerville, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/350,558

(22) Filed: Feb. 8, 2006

(51) Int. Cl. G06F 15/16

(52) U.S. Cl. 709/208

(57) ABSTRACT

A method and system to communicate with a remote control are described herein. A device mode is selected from a plurality of device modes, each of which is associated with a media device. A user makes the selection in response to a prompt received from the media device. Next, mode data, which is associated with the selected device mode, is transmitted from the media device to a remote control. The remote control includes a plurality of selectively illuminated indicators. Furthermore, predetermined indicators from the plurality of selectively illuminated indicators are illuminated in response to the transmission of the mode data.

### FIELD

The application relates generally to the field of multimedia processing, and more specifically to communicating with a remote control.

### BACKGROUND

Remote controls for consumer audio/video equipment, particularly multi-function equipment, such as a set-top box with multiple functions such as television, digital video recorder (DVR), video cassette recorder (VCR), music audio, photos storage, and/or another other media functions, have become increasingly complicated. Because of the dozens of buttons to choose from, a user may have difficulty finding an appropriate and desired button on the remote control to activate a certain command. The plethora of remaining buttons may introduce visual complication. For example, the transport buttons (FF, RW, play, pause, etc.) are used during playback of a DVR program, and the remaining buttons, such as channel change, are not used during this operation. These remaining buttons may confuse the user as they attempt to complete their current task.

### BRIEF DESCRIPTION OF DRAWINGS

An example embodiment of the present invention is illustrated by way of example and not limitation in the figures of the accompanying drawings, in which like references indicate similar elements and in which:

FIG. 1 illustrates an Internet Protocol Television (IPTV) system environment in which one embodiment may be implemented.

FIGS. 2A and 2B illustrate an interactive system between a device and a remote control in a first device mode where indicators of the remote control are selectively illuminated according to one embodiment.

FIGS. 3A and 3B illustrate an interactive system between a device and a remote control in a second device mode where indicators of the remote control are selectively illuminated according to one embodiment.

FIG. 4 illustrates a method of interaction between a device and remote control according to one embodiment.

FIG. 5 shows a diagrammatic representation of machine in the example form of a computer system within which a set of instructions, for causing the machine to perform any one or more of the methodologies discussed herein, may be executed.

### DETAILED DESCRIPTION

According to an aspect of the present subject matter there is provided a method and system to communicate with a remote control. A device mode is selected from a plurality of device modes by a user, in response to a prompt from a media device. Mode data associated with the selected device mode is transmitted from the media device to a remote control. The remote control includes a plurality of selectively illuminated indicators. Predetermined indicators for the plurality of selectively illuminated indicators are illuminated in response to a transmission of the mode data from the selected device mode of the media device.

In the following description, for the purposes of explanation, numerous specific details are set forth in order to provide a thorough understanding of the disclosed embodiments. It will be apparent, however, to one skilled in the art that the disclosed embodiments may be practiced without some of these specific details. In other instances, well-known structures and devices are shown in block diagram form.

Example Internet Protocol Television System Environment

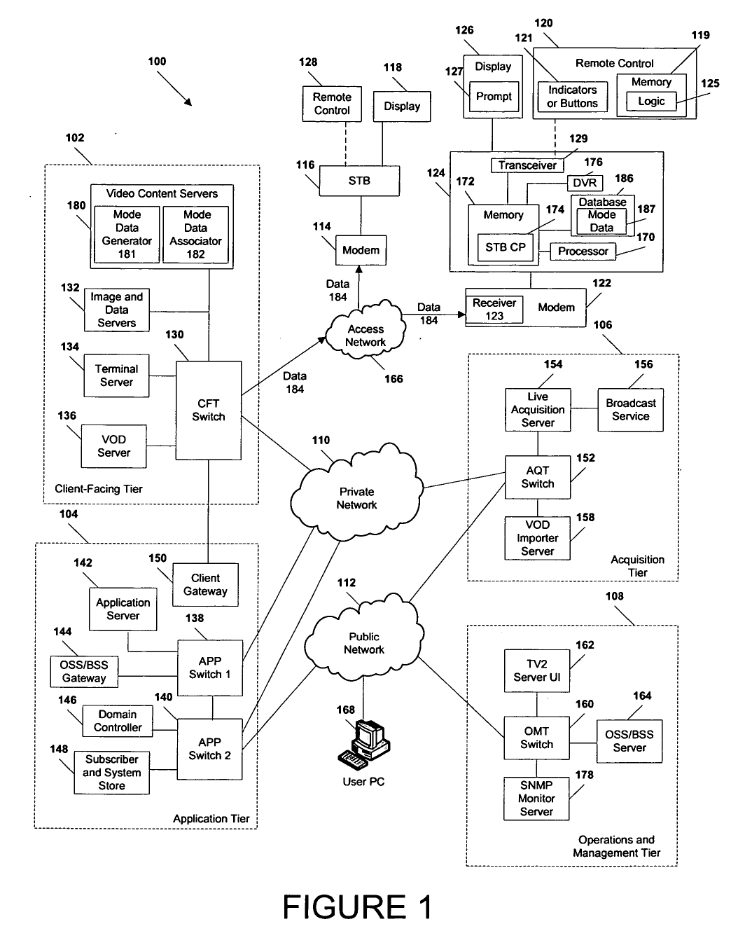

Referring to FIG. 1, an illustrative embodiment of an Internet Protocol Television (IPTV) system that may be used to provide video content is illustrated and is generally designated 100. As shown, the system 100 may include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 may be coupled to the private network 110. Further, the application tier 104 may be coupled to the private network 110 and to the public network 112. The acquisition tier 106 may also be coupled to the private network 110 and to the public network 112. Additionally, the operations and management tier 108 may be coupled to the public network 112.

As illustrated in FIG. 1, the various tiers 102, 104, 106, 108 communicate with each other via the private network 110 and the public network 112. For instance, the client-facing tier 102 may communicate with the application tier 104 and the acquisition tier 106 via the private network 110. The application tier 104 may also communicate with the acquisition tier 106 via the private network 110. Further, the application tier 104 may communicate with the acquisition tier 106 and the operations and management tier 108 via the public network 112. Moreover, the acquisition tier 106 may communicate with the operations and management tier 108 via the public network 112. In a particular embodiment, elements of the application tier 104, including, but not limited to, a client gateway 150, may communicate directly with the client-facing tier 102.

As illustrated in FIG. 1, the client-facing tier 102 may communicate with user equipment via a private access network 166, such as an Internet Protocol Television (IPTV) access network. In an illustrative embodiment, modems, such as a first modem 114 and a second modem 122 may be coupled to the private access network 166. The client-facing tier 102 may communicate with a first representative set-top box device 116 via the first modem 114 and with a second representative set-top box device 124 via the second modem 122. Each modem 114, 122 may include a receiver, such as receiver 123 of modem 122, to receive the data 184, for instance. The client-facing tier 102 may communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that may be supported by networking the client-facing tier 102 to numerous set-top box devices. In an illustrative embodiment, the client-facing tier, or any portion thereof, may be included at a video head-end office.

The set-top box 116, 124 may generally be considered a media device. The media device may be a cable box, a set top box, a transmitter, a multifunctional device, a digital video recorder, a television, a video cassette recorder, a computer, a multifunctional device, or any other media device.

In a particular embodiment, the client-facing tier 102 may be coupled to the modems 114, 122 via fiber optic cables. Alternatively, the modems 114 and 122 may be digital subscriber line (DSL) modems that are coupled to one or more network nodes via twisted pairs, and the client-facing tier 102 may be coupled to the network nodes via fiber-optic cables. Each set-top box device 116, 124 may process data received via the private access network 166, via an IPTV software platform, such as Microsoft® TV IPTV Edition.

Further, the set-top box devices 116, 124 may each include a STB processor, such as STB processor 170, and a STB memory device, such as STB memory 172, which is accessible to the STB processor 170. In one embodiment, a computer program, such as the STB computer program (STB CP) 174, may be embedded within the STB memory device 172.

Additionally, the first set-top box device 116 may be coupled to a first external display device 118, such as a first television monitor, and the second set-top box device 124 may be coupled to a second external display device 126, such as a second television monitor. The display 118, 126 may optionally show on screen commands or a prompt 127, such as a device mode selection prompt for the user to select a device mode of the device 116, 124 as described in more detail herein.

The first set-top box device 116 may communicate with a first remote control 128, and the second set-top box device may communicate with a second remote control 120. The remote control 120, 128 may have dynamic remote control backlighting capability as described herein.

The device 116, 124 may include a wireless transceiver (e.g., transmitter and/or receiver) 129 to communicate with a wireless transmitter/receiver (not shown) of the remote control 120, 128. The device 116, 124 further includes logic (e.g., STB CP 174) to determine user context (e.g., device mode) and to determine remote control backlighting profiles that may be associated with the user context. These backlighting profiles may be transmitted to the remote control in conjunction with the determined context.

The remote control 120, 128 may include multiple indicators 121 capable of being selectively illuminated or backlit, in particular, in response to the transmitted backlighting profiles. The remote control 120, 128 may include memory 119 with logic 125 to illuminate the indicators or buttons 121 based on the received backlit profiles. The plurality of selectively illuminated indicators may include icons (e.g., for use on an LCD screen), buttons, selection keys, a track ball, a wheel, and/or a switch of the remote control.

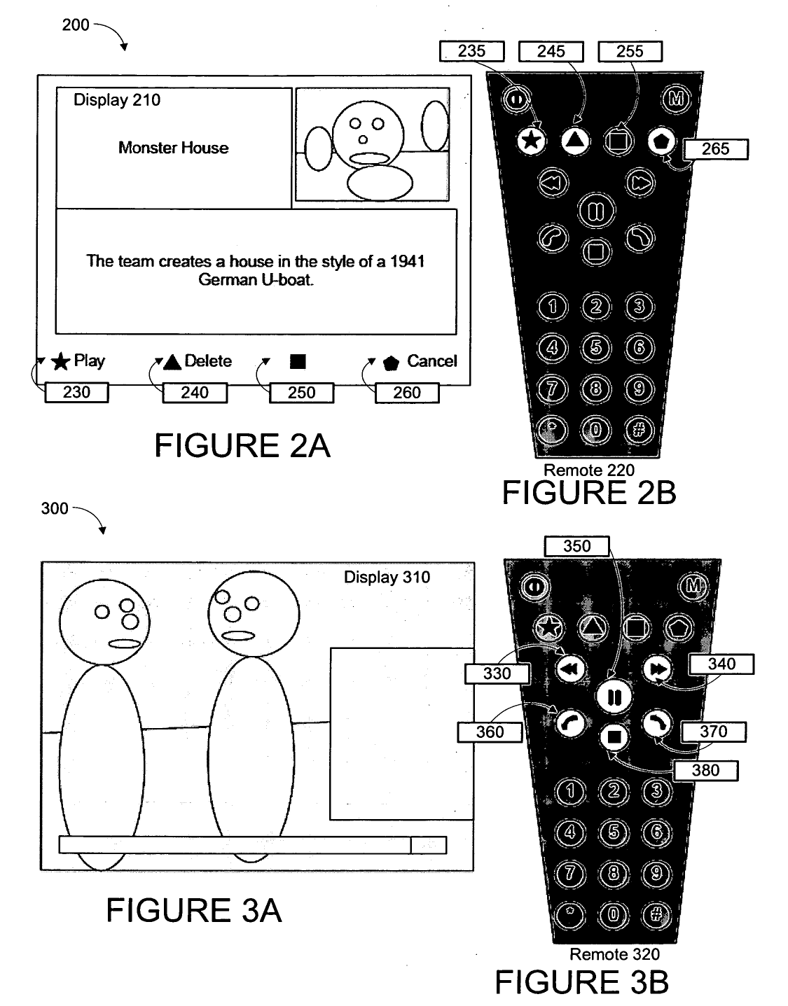

The device 116, 124 causes the prompt 127 to display on the display 126, for instance. The prompt 127 indicates a selection of a plurality of device modes available through the device 116, 124. For instance, a first device mode may include a selected device mode where a user may choose which program to watch or record on a DVR (e.g., FIG. 2A). A second device mode may include a play mode where a user watches a recorded DVR program (e.g., FIG. 3A). A third device mode may include a watch mode where a user watches a television program while having DVR options. A fourth device mode may be a different media, such as a selection mode where a user may choose which musical compact disc (CD) to listen to, or to watch regular programming, or to view saved photographs or any other media that may be available.

A device mode from the plurality of device modes may be selected by a user in response to the prompt 127 of the display 128, for instance. The selection may be made using the remote control 120, 128. The device 116, 124 transmits mode data 187, such as a backlighting profile, associated with the selected device mode, to the remote control 120, 128, in response to the selection made. The remote control 120, 128 uses this backlighting profile to selectively illuminate indicators 121 appropriate to the selected device mode or context. In the described embodiments, the device 116, 124 and the remote control 120, 128 maintain a two-way connection and interaction.

The mode data corresponding to each of the plurality of device modes of the media device 116, 124 may be generated using a mode data generator 181 of video content servers 180 of the client-facing tier 102. A mode data associator 182 may associate the generated mode data with the particular device mode to transmit the associated mode data to the remote control 120 to illuminate the predetermined indicators 121 of the plurality of remote control indicators, wherein the predetermined indicators correspond to a device mode selection in response to the user prompt 127. Additionally or alternatively to the content servers 180, mode data may be generated, associated, and provided by an outside database, the device 116, 124, and/or a user of the device 116, 124, in other embodiments not shown. In an embodiment, the media device may be responsive to the mode data associator 182 and may communicate the mode data to the remote control. The media device may have the DVR as part of the device 124, as shown in FIG. 1. In another embodiment, the DVR may be a network DVR.

In an example, non-limiting embodiment, each set-top box device 116, 124 may receive data 184, which may include video content and/or audio content or portions, or mode data, from the client-facing tier 102 via the private access network 166. The data 184 may be associated with at least one program, such as a broadcast program itself, or may be associated with each of the plurality of device modes. The data may include program content data associated with the at least one program.

The set-top boxes 116, 124 may transmit the data 184 to an external display device, such as the display devices 118, 126 for displaying a program, for instance. Also, the device 116, 124 may transmit logic from STB CP 174 for the display 126 to display the prompt 127.

The memory 172 of the device 116, 124 may be coupled with a database 186 including mode data 187, e.g. context data, and including the backlighting profiles to be transmitted to the remote control 120, 128.

Each set-top box device 116, 124 may also include a video content storage module, such as a digital video recorder (DVR) 176. In a particular embodiment, the set-top box devices 116, 124 may communicate commands received from the remote control devices 120, 128 to the client-facing tier 102 via the private access network 166.

In an illustrative embodiment, the client-facing tier 102 may include a client-facing tier (CFT) switch 130 that manages communication between the client-facing tier 102 and the private access network 166 and between the client-facing tier 102 and the private network 110. As shown, the CFT switch 130 is coupled to one or more image and data servers 132 that store still images associated with programs of various IPTV channels. The image and data servers 132 may also store data related to various channels, e.g., types of data related to the channels and to programs or video content displayed via the channels. In an illustrative embodiment, the image and data servers 132 may be a cluster of servers, each of which may store still images, channel and program-related data, or any combination thereof. The CFT switch 130 may also be coupled to a terminal server 134 that provides terminal devices with a connection point to the private network 110. In a particular embodiment, the CFT switch 130 may also be coupled to a video-on-demand (VOD) server 136 that stores or provides VOD content imported by the IPTV system 100. The client-facing tier 102 may also include one or more video content servers 180 that transmit video content requested by viewers via their set-top boxes 116, 124. In an illustrative, non-limiting embodiment, the video content servers 180 may include one or more multicast servers.

As illustrated in FIG. 1, the application tier 104 may communicate with both the private network 110 and the public network 112. The application tier 104 may include a first application tier (APP) switch 138 and a second APP switch 140. In a particular embodiment, the first APP switch 138 may be coupled to the second APP switch 140. The first APP switch 138 may be coupled to an application server 142 and to an OSS/BSS gateway 144. In a particular embodiment, the application server 142 may provide applications to the set-top box devices 116, 124 via the private access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 may provide or restrict access to an OSS/BSS server 164 that stores operations and billing systems data.

Further, the second APP switch 140 may be coupled to a domain controller 146 that provides web access, for example, to users via the public network 112. For example, the domain controller 146 may provide remote web access to IPTV account information via the public network 112, which users may access using their personal computers 168. The second APP switch 140 may be coupled to a subscriber and system store 148 that includes account information, such as account information that is associated with users who access the system 100 via the private network 110 or the public network 112. In a particular embodiment, the application tier 104 may also include a client gateway 150 that communicates data directly with the client-facing tier 102. In this embodiment, the client gateway 150 may be coupled directly to the CFT switch 130. The client gateway 150 may provide user access to the private network 110 and the tiers coupled thereto.

In a particular embodiment, the set-top box devices 116, 124 may access the IPTV system 100 via the private access network 166, using information received from the client gateway 150. In this embodiment, the private access network 166 may provide security for the private network 110. User devices may access the client gateway 150 via the private access network 166, and the client gateway 150 may allow such devices to access the private network 110 once the devices are authenticated or verified. Similarly, the client gateway 150 may prevent unauthorized devices, such as hacker computers or stolen set-top box devices from accessing the private network 110, by denying access to these devices beyond the private access network 166.

For example, when the first representative set-top box device 116 accesses the system 100 via the private access network 166, the client gateway 150 may verify subscriber information by communicating with the subscriber and system store 148 via the private network 110, the first APP switch 138, and the second APP switch 140. Further, the client gateway 150 may verify billing information and status by communicating with the OSS/BSS gateway 144 via the private network 110 and the first APP switch 138. In one embodiment, the OSS/BSS gateway 144 may transmit a query across the first APP switch 138, to the second APP switch 140, and the second APP switch 140 may communicate the query across the public network 112 to the OSS/BSS server 164. After the client gateway 150 confirms subscriber and/or billing information, the client gateway 150 may allow the set-top box device 116 access to IPTV content and VOD content. If the client gateway 150 cannot verify subscriber information for the set-top box device 116, e.g., because it is connected to an unauthorized twisted pair, the client gateway 150 may block transmissions to and from the set-top box device 116 beyond the private access network 166.

As indicated in FIG. 1, the acquisition tier 106 includes an acquisition tier (AQT) switch 152 that communicates with the private network 110. The AQT switch 152 may also communicate with the operations and management tier 108 via the public network 112. In a particular embodiment, the AQT switch 152 may be coupled to a live acquisition server 154 that receives television or movie content, for example, from a broadcast service 156. In a particular embodiment during operation of the IPTV system, the live acquisition server 154 may acquire television or movie content. The live acquisition server 154 may transmit the television or movie content to the AQT switch 152, and the AQT switch 152 may transmit the television or movie content to the CFT switch 130 via the private network 110.

Further, the television or movie content may be transmitted to the video content servers 180, where it may be encoded, formatted, stored, or otherwise manipulated and prepared for communication to the set-top box devices 116, 124. The CFT switch 130 may communicate the television or movie content to the modems 114, 122 via the private access network 166. The set-top box devices 116, 124 may receive the television or movie content via the modems 114, 122, and may transmit the television or movie content to the display devices 118, 126. In an illustrative embodiment, video or audio portions of the television or movie content may be streamed to the set-top box devices 116, 124.

Further, the AQT switch may be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 may receive content from one or more VOD sources outside the IPTV system 100, such as movie studios and programmers of non-live content. The VOD importer server 158 may transmit the VOD content to the AQT switch 152, and the AQT switch 152, in turn, may communicate the material to the CFT switch 130 via the private network 110. The VOD content may be stored at one or more servers, such as the VOD server 136.

When user issue requests for VOD content via the set-top box devices 116, 124, the requests may be transmitted over the private access network 166 to the VOD server 136, via the CFT switch 130. Upon receiving such requests, the VOD server 136 may retrieve the requested VOD content and transmit the content to the set-top box devices 116,124 across the private access network 166, via the CFT switch 130. The set-top box devices 116, 124 may transmit the VOD content to the display devices 118, 126. In an illustrative embodiment, video or audio portions of VOD content may be streamed to the set-top box devices 116, 124.

FIG. 1 further illustrates that the operations and management tier 108 may include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 may be coupled to an OSS/BSS server 164 and to a simple network management protocol (SNMP) monitor server 178 that monitors network devices within or coupled to the IPTV system 100. In a particular embodiment, the OMT switch 160 may communicate with the AQT switch 152 via the public network 112.

In an illustrative embodiment, the live acquisition server 154 may transmit the television or movie content to the AQT switch 152, and the AQT switch 152, in turn, may transmit the television or movie content to the OMT switch 160 via the public network 112. In this embodiment, the OMT switch 160 may transmit the television or movie content to the TV2 server 162 for display to users accessing the user interface at the TV2 server 162. For example, a user may access the TV2 server 162 using a personal computer (PC) 168 coupled to the public network 112.

Example Interactive Systems

FIGS. 2A and 2B illustrate an interactive system 200 between the display 118, 126 of the device 116, 124 and the remote control 120, 128 in the first device mode where indicators of the remote control are selectively illuminated according to one embodiment. This illustrated first device mode includes a selection device mode wherein a user may choose which program to watch using a recording device, such as a DVR. The display illustrates a detail page for a DVR event. This screen design involves contextual soft keys 230, 240, 250, 260 at the bottom of the page, for example, corresponding to remote buttons 235, 245, 255, 265.

In this example, the soft keys 230, 240, 250, 260 and buttons 235, 245, 255, 265 include corresponding symbols, e.g. the on screen “star” icon 230 corresponds to the “star” button 235 on the remote. In this example, there are at least three possible commands for the user: play (star), delete (triangle), and cancel (pentagon).

Note that on this particular screen the square key 250 and corresponding button 255 does not have an assigned function. As a result, the button 255 is not illuminated in this embodiment. In an alternative embodiment, the button 255 is lit more dimly than the illuminated or highlighted buttons 235, 245, 265.

The indicators 235, 245, 265 may correspond to available on-screen commands or prompts 127 on the display 118, 126. The indicators 235, 245, 265 may be illuminated in colors that correspond to illuminated colors of the soft keys (e.g., selection keys) 230, 240, 260. Each of the colors of the indicators 121 may be the same, e.g., all blue lit indicators in the first device mode, and these blue lit indicators may correspond to blue icons of the on-screen choices in some embodiments. In an additional embodiment, each of the indicators 235, 245, 265 may be illuminated with a different color and correspond to the different colors associated with the soft keys (e.g., selection keys) 230, 240, 260. In other embodiments, the layout of the soft keys 230, 240, 250, 260 may correspond to the layout of the illuminated indicators 235, 245, 255, 265 of the backlighting profile on the remote control, as shown in FIGS. 2A and 2B. For example, the order and the alignment of the soft keys on the display may correspond to the order and alignment of the highlighted (e.g., illuminated) indicators on the remote control during a particular mode or a prompt for a response.

In an additional embodiment, the indicators 121 of the remote control may correspond to available commands of the device 116, 124, even when there is no on-screen command or prompt, or even when there is no display 118, 126, for example, when the device includes an audio system.

FIGS. 3A and 3B illustrate an interactive system 300 between the device 116, 124 and the remote control 120, 128 in the second device mode where indicators of the remote control are selectively illuminated according to one embodiment. This illustrated second device mode includes a play mode wherein a user watches a recorded DVR program. In the first device mode of FIG. 2A, the user may have selected the “star” button 235 or play button 235 of the remote control 220 to move to a different context or device mode.

In this device mode, the transport buttons (e.g., rewind 330, fast forward 340, pause 350, chapter behind 360, chapter advance 370, and stop 380, for instance) corresponding with the play mode are each illuminated. Other buttons, including buttons used in the previous context or device mode, are not lit or are dimly lit.

Each of the colors of the indicators 330, 340, 350, 360, 370, and 380, may be the same, e.g., all green lit indicators in the second device mode. The predetermined indicators may include a first illuminated color while in the first selected device mode and a second illuminated color while in the second selected device mode.

Flow Chart

The steps described below may be performed under the control of a programmed processor, such as processor 302, or the logic may be implemented and distributed among hardware, firmware, software, or a combination thereof within the digital video recorder 176, for example.

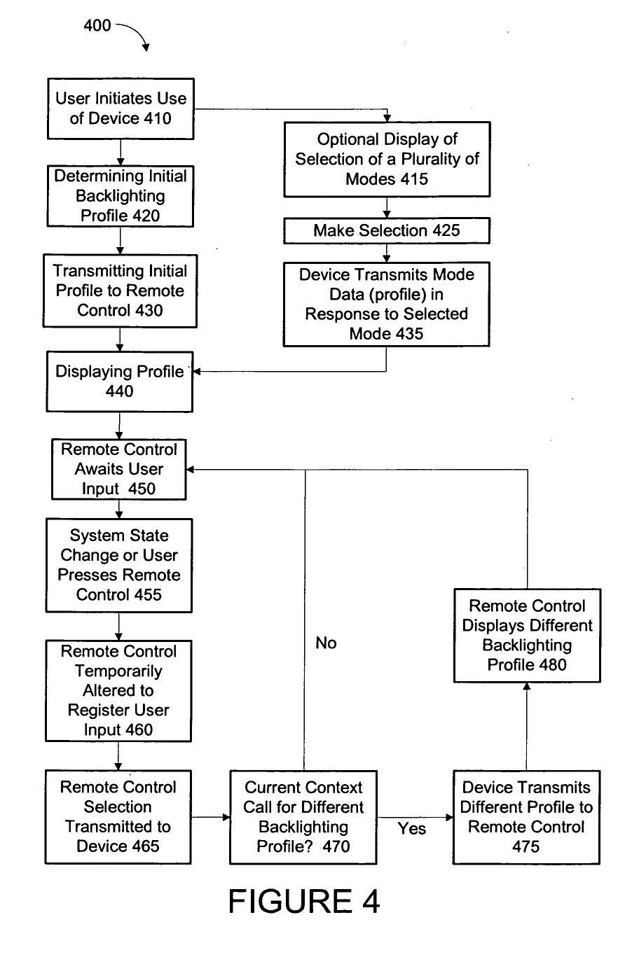

FIG. 4 illustrates a method 400 of interaction between the device 116, 124 and the remote control 120, 128 according to one embodiment. The context or device mode of the device 116, 124 determines the backlighting profile displayed on the remote control.

At block 410, a user may initiate use of the device 116, 124, for example, by powering on the device 116, 124. The device 116, 124 may be powered on by pressing a power button on the remote control 120, 128. The flowchart may continue at block 420 or block 415.

At block 420, an initial backlighting profile of the remote control may be utilized when the user begins use of the device 116, 124. This initial backlighting profile may be resident in a remote control memory 119, or in the memory 172 of the device 116, 124. In the latter case, the initial backlighting profile may be transmitted to the remote control at block 430. The initial backlighting profile may be based on a start up profile when the device 116, 124 is switched on or may be the last device mode in which the user left the device 116, 124.

At block 415, the device 116, 124 may optionally display on the display 126 a selection of a plurality of device modes. The selection display may be in the form of the mode selection prompt 127 on the display 118, 126, for instance. In an embodiment, indicators 121 on the remote control may be selectively illuminated in response to the prompt 127. In other embodiments, the indicators 121 are not illuminated in response to the prompt, but rather illuminate in response to other means, such as a direct transmission from the device 116, 124 to a default mode, for instance. The method continues at block 425.

At block 425, a device mode selection is made. The remote control may be used to make the device mode selection and may or may not be in response to the prompt 127. The method continues at block 435.

At block 435, the device 116, 124 may transmit the mode data (profile) corresponding to the selected device mode in response to the selection to the remote control 120. The method continues at block 440.

At block 440, the remote control displays the illuminated profile of the selectively illuminated indicators 121 in response to the transmission of mode data from the device 116, 124, either from block 430 or from block 435.

At block 450, the remote control may wait for user input or a change in system state (e.g., notifying the user of interest items, such as event notification, arrival of an instant message, or flashing indicators in response to a “find lost remote” button pressed on the device, for instance). The remote control may additionally wait for a change in device mode (from watch DVR to watch TV, for instance, or the user pressing of one of the indicators 121).

The selected indicators 121 may stay lit while the device 116, 124 is in the selected device mode, or the illumination of the selected indicators may fade out completely or to a minimal luminescence after an interval of time without activity to preserve battery life. Illuminated indicators 121 may revive when one or more of the following occurs: a motion sensor is activated, a remote control button is pressed, and a mercury switch is activated.

At block 455, the device mode changes (e.g., from one mode (DVR) to another mode (TV)), the user presses an indicator, or the system state changes.

At block 460, the illumination of the remote control display may be temporarily altered when one of the indicators 121 is selected by a user. For example, the selected indicator may darken, lighten, get brighter, or may change color to indicate, for example, successful receipt of button press.

At block 465, the selection of the indicator may be transmitted to the device 116, 124.

At block 470, the method queries as to whether the current context or device mode calls for a different backlighting profile. The device 116, 124 determines if the context or device mode has changed sufficiently to warrant an update to the back lighting profile. If the answer is yes, the method continues at block 475. If the answer is no, the method continues at block 450 to loop around again until power to the device 116, 124 is turned off.

At block 475, the device 116, 124 transmits a different backlighting profile (e.g., mode data) to the remote control. In an additional embodiment, the memory 119 of the remote control includes the different possible backlighting profiles and the device sends a code in the mode data that corresponds to the appropriate backlighting profile. The memory 119 and/or logic 125 of the remote control 120 may be able to interpret the transmitted mode data from the device to determine which indicators to illuminate. Therefore, this technology may be used with many different remote controls that are not preprogrammed specifically with the device 116, 124, yet are still compatible.

At block 480, the remote control displays the different backlighting profile upon receipt of the mode data. The method continues at block 450 until the device 116, 124 is turned off or powered down.

In embodiments, the two-way communication between the device 116, 124 and the remote control 120, 128 may be used to notify the user of interest items, such as arrival of a message from another user, or to help locate a lost remote control. In embodiments, one or more indicators 121 may flash or illuminate when a button on the device 116, 124 is pressed to find the lost remote control or when a message has been received.

Means for selecting a device mode by a user response to the prompt 127 may include the indicators 121, for instance. Means for transmitting mode data associated with the selected device mode from the device 116, 124 to the remote control 120 may include the transceiver 129, for instance. Means for illuminating predetermined indicators of the plurality of selectively illuminated indicators in response to transmission of the mode data of the selected device mode from the device 116, 124 may include the logic 125, for instance. Means for temporarily altering the illumination of one of the predetermined indicators when selected by a user may include the logic 125, for instance.

Computer Architecture

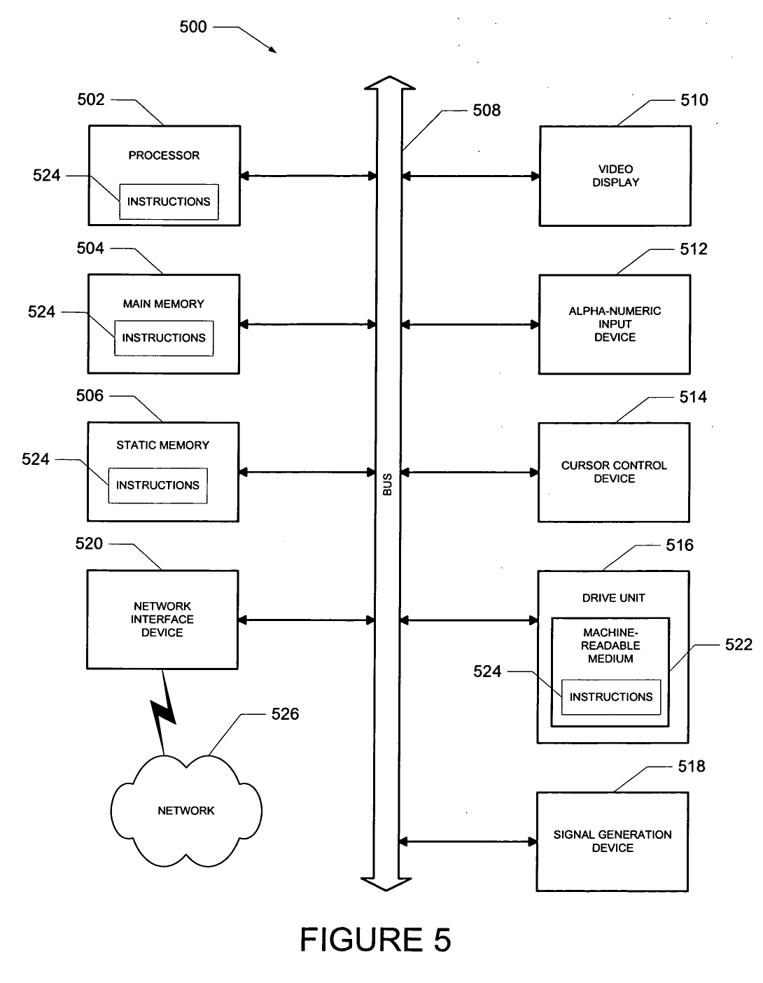

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a digital video recorder (DVR), a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The main memory 504 and/or the static memory 506 may be used to store the recorded programs and/or the look up tables.

The computer system 500 may further include a video display unit 510 (e.g., a television, a liquid crystal display (LCD) or a cathode ray tube (CRT)) on which to display broadcast or other programs, for example. The computer system 500 also includes an alphanumeric input device 512 (e.g., a keyboard or a remote control), a user interface (UI) navigation device 514 (e.g., a remote control, or a mouse), a disk drive unit 516, a signal generation device 518 (e.g., a speaker) and a network interface device 520.

The input device 512 and/or the navigation device 514 (e.g., the remote control) may include a processor (not shown), and a memory (not shown). The memory may be used to store the profiles and/or to store look up tables associating the mode data with the profiles, for instance.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 and/or the data stream 184 from the content provider may further be transmitted or received over a network 526 (e.g., a television cable provider) via the network interface device 520 utilizing any one of a number of well-known transfer protocols (e.g., broadcast transmissions, HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A system to communicate with a remote control, the system comprising:
a media device including a plurality of device modes and a particular device mode from the plurality of device modes to be selected by a user in response to a prompt received from the media device,
wherein the media device is to transmit mode data, which is associated with the selected device mode, to a remote control having predetermined indicators of a plurality of selectively illuminated indicators to be illuminated in response to the transmission of the mode data.

2. The system of claim 1 further comprising:
a display of the media device to present the prompt from the media device, wherein the user response to the prompt is received by the media device from the remote control.

3. The system of claim 1 wherein the predetermined indicators of the plurality of selectively illuminated indicators are illuminated from default mode data of the media device.

4. The system of claim 1 further comprising a media device indicator to illuminate a corresponding indicator of the remote control, wherein the corresponding illuminated indicator aids the user in finding the remote control.

5. A method to communicate with a remote control, the method comprising:
prompting, from a media device, a selection of a particular device mode from a plurality of device modes of the media device; and
transmitting mode data associated with the selected device mode from the media device to a remote control having a plurality of selectively illuminated indicators to be illuminated in response to the transmission of the mode data.

6. The method of claim 5 further comprising:
presenting the prompt on a display of the media device; and
receiving a user response to the prompt through the remote control.

7. A system to communicate with a remote control, the system comprising:
means for prompting, from a media device, a selection of a particular device mode from a plurality of device modes of the media device; and
means for transmitting mode data associated with the selected device mode from the media device to a remote control having a plurality of selectively illuminated indicators to be illuminated in response to the transmission of the mode data.

8. The system of claim 7 wherein the means for prompting includes a prompt presented on a display of the media device.

9. A tangible machine readable medium storing a set of instructions that, when executed by a machine, cause the machine to:
prompt, from a media device, a selection of a particular device mode from a plurality of device modes of the media device; and
transmit mode data associated with the selected device mode from the media device to a remote control having a plurality of selectively illuminated indicators to be illuminated in response to the transmission of the mode data.

10. The medium of claim 9 further to:
present, on a display, the prompt; and
receive a user response to the prompt through the remote control.

11. A system to communicate with a media device, the system comprising:
a remote control having a plurality of selectively illuminated indicators,
wherein at least one of the plurality of selectively illuminated indicators is used to select a particular device mode from a plurality of device modes of a media device in response to a prompt from the media device,
wherein predetermined indicators of the plurality of selectively illuminated indicators are illuminated in response to a transmission of mode data of the media device, wherein the mode data is associated with the selected device mode.

12. The system of claim 11 wherein the predetermined indicators include a first illuminated color while in a first selected device mode and a second illuminated color while in a second selected device mode.

13. The system of claim 11 wherein the predetermined indicators include different illuminated symbols that correspond to different commands.

14. The system of claim 11 wherein a layout of the predetermined indicators on the remote control corresponds with a layout of a plurality of selection keys on a display of the media device.

15. The system of claim 11 wherein indicators of the plurality of selectively illuminated indicators are illuminated in response to a system status change.

16. The system of claim 11 wherein the predetermined indicators include backlit buttons that remain illuminated until another device mode from the plurality of device modes is selected.

17. The system of claim 11 wherein the predetermined indicators selectively illuminate in response to the prompt and in response to the transmission of the mode data.

18. A method to communicate with a media device, the method comprising:
using at least one of a plurality of selectively illuminated indicators of a remote control to select a particular device mode from a plurality of device modes of a media device in response to a prompt from the media device;
receiving a transmission of mode data of the media device, wherein the mode data is associated with the selected device mode; and
illuminating predetermined indicators of the plurality of selectively illuminated indicators in response to the transmission of mode data.

19. The method of claim 18 further comprising darkening the illumination of one of the predetermined indicators when selected by a user.

20. The method of claim 18 further comprising lightening the illumination of one of the predetermined indicators when selected by a user.

21. The method of claim 18 further comprising changing color of one of the predetermined indicators when selected by a user.

22. The method of claim 18 further comprising dimly lighting non-suggested indicators of the plurality of selectively illuminated indicators in comparison to the illuminated predetermined indicators.

23. The method of claim 18 further comprising temporarily altering the illumination of one of the predetermined indicators when selected by a user.

24. The method of claim 18 wherein the illuminated indicators of the remote control are selected from a group of fading and turning off to preserve battery life after a predetermined amount of time without activity.

25. The method of claim 18 wherein the illuminated indicators revive when there is an occurrence selected from a group including activating a motion sensor, pressing one of the plurality of selectively illuminated indicators, and activating a mercury switch.

26. A system to communicate with a remote control, the system comprising:
an interface with a prompt used in selection of a device mode from a plurality of device modes, each of which is associated with a media device; and
a transmitter to transmit mode data associated with the selected device mode from the media device to a remote control, wherein predetermined indicators on the remote control are illuminated in response to transmission of the mode data.

27. The system of claim 26 wherein the interface includes a plurality of selection keys having a layout that corresponds with a layout of the predetermined indicators on the remote control.

28. A system to associate mode data with a device mode to communicate with a remote control, the system comprising:
a mode data generator to generate mode data corresponding to each of a plurality of device modes of a media device; and
a mode data associator to associate the generated mode data with a user-selected device mode from the plurality of device modes, wherein the associated mode data is suitable for transmission to a remote control to illuminate predetermined indicators of a plurality of remote control indicators, wherein the predetermined indicators correspond to the user-selected device mode made in response to a prompt.

29. The system of claim 28 further comprising the media device responsive to the mode data associator and to communicate the mode data to the remote control.
